(19) United States
(12) Patent Application Publication
(10) Pub. No.: US 2002/0001719 A1
(43) Pub. Date: Jan. 3, 2002

(54) Laminated sheet and method of manufaturing the same

(75) Inventor: Yasuhiro Horiba, Ogaki-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: IBIDEN CO., LTD., Ogaki-shi (JP)

(21) Appl. No.: 09/843,731

(22) Filed: Apr. 30, 2001

Related U.S. Application Data
(63) Continuation of application No. PCT/JP99/05825, filed on Oct. 21, 1999.

(30) Foreign Application Priority Data
Oct. 28, 1998 (JP) 10-306954

(51) Int. Cl. B32B 31/00

(52) U.S. Cl. 428/411.1; 156/250; 156/260

(57) ABSTRACT

A laminated sheet made from a sheet roll that is formed by biaxially rolling a resin ingot includes a first sheet and a second sheet. The first sheet is cut out from one side of the sheet roll with respect to a center of a width (W) of the sheet roll. The first sheet has an outer surface which corresponds to a roll outer surface of the sheet roll. The second sheet is cut out from the one side of the sheet roll and has an inner surface which corresponds to a roll inner surface of the sheet roll. The first and second sheets are laminated so that the outer surface of the first sheet faces toward the inner surface of the second sheet.

### CROSS-REFERENCE TO RELATED APPLICATION

The present application claims priority under 35 U.S.C. §119 to Japanese Patent Application No.10-306954, filed Oct. 28, 1998. Further, the present application claims priority under 35 U.S.C. §120 to International Application No. PCT/JP99/05825, filed Oct. 21, 1999, entitled “METHOD OF MANUFACTIURING LAMINATED SHEET.” The contents of these applications are incorporated herein by reference in their entirety.

### BACKGROUND OF THE INVENTION

1. Field of the Invention

The present invention relates to a laminated sheet made from a sheet roll and a method of manufacturing the laminated sheet.

2. Discussion of the Background

Conventionally, the laminated sheets made by laminating a plurality of layers of resin sheets have been used in applications such as wiring boards, IC cards, and the like. Such laminated sheets are, as shown in FIG. 9, manufactured by cutting off sections of sheet 2A to 2F from a sheet roll 1 that was formed by winding a long-size resin sheet (a single sheet) in the from of a roll and laminating the thus cut off sections of sheet. Furthermore, in some cases, a sheet other than the sheets that are cut off from the sheet roll 1 is also laminated. Note that between layers of the sheets laminated together, wiring patterns and the like are sandwiched. These wiring patterns and the like are usually formed beforehand on a surface of the sheet that will be sandwiched between layers. Lamination of the sheets is usually processed at a temperature of about 80° C.

Such a laminated sheet is likely to develop warping as shown in FIG. 10. For this reason, a flat laminated sheet is rather difficult to obtain. This is because a curl caused by a state of being wound up as the sheet roll remains in a section of sheets that is a constituent of the laminated sheet. Especially, when the laminated sheet is heated again afterward for mounting IC's, coating, and the like, warping often develops prominently. Because of this, when sections of sheet are laminated together, there is devised a method of superposing the sections of sheet in such a way that surfaces of the sections of sheet both of which were the inner surface or the outer surface in the sheet roll are opposed to each other, and the like, with the intention of offsetting the curl caused by winding. Here, there is a case where three or more sections of sheet are laminated together. This is because it is difficult to prevent warping of the sheet completely by merely laminating the two sections of sheet as described above.

However, deformation of a laminated sheet is a more complicated phenomenon than having been expected, and there are not only warping as shown in FIG. 10 but also twist as shown in FIG. 11. This twist does not result from the curl caused by winding in the sheet roll. Therefore, twist cannot be prevented only by offsetting the curl caused by the winding as in the above-mentioned technique.

### SUMMARY OF THE INVENTION

According to one aspect of the invention, a method of manufacturing a laminated sheet made from a sheet roll that is formed by biaxially rolling a resin ingot includes cutting out first and second sheets from a same side of the sheet roll with respect to a center of a width (W) of the sheet roll. The first sheet has an outer surface which corresponds to a roll outer surface of the sheet roll. The second sheet has an inner surface which corresponds to a roll inner surface of the sheet roll. The first and second sheets are laminated so that the outer surface of the first sheet faces toward the inner surface of the second sheet.

According to another aspect of the invention, a method of manufacturing a laminated sheet made from a sheet roll that is formed by biaxially rolling a resin ingot includes cutting out a first sheet from a first side of the sheet roll and a second sheet from a second side of the sheet roll which locates on an opposite side of the first side with respect to a center of a width (W) of the sheet roll. The first sheet has a first outer surface which corresponds to a roll outer surface of the sheet roll. The first sheet has a first inner surface which corresponds to a roll inner surface of the sheet roll. The second sheet has a second outer surface which corresponds to the roll outer surface. The second sheet has a second inner surface which corresponds to the roll inner surface. The first and second sheets are laminated so that the first and second outer surfaces face each other or the first and second inner surfaces face each other.

According to further aspect of the invention, a laminated sheet made from a sheet roll that is formed by biaxially rolling a resin ingot includes a first sheet and a second sheet. The first sheet is cut out from one side of the sheet roll with respect to a center of a width (W) of the sheet roll. The first sheet has an outer surface which corresponds to a roll outer surface of the sheet roll. The second sheet is cut out from the one side of the sheet roll and has an inner surface which corresponds to a roll inner surface of the sheet roll. The first and second sheets are laminated so that the outer surface of the first sheet faces toward the inner surface of the second sheet.

According to the other aspect of the invention, a laminated sheet made from a sheet roll that is formed by biaxially rolling a resin ingot includes a first sheet and a second sheet. The first sheet is cut out from a first side of the sheet roll. The first sheet has a first outer surface which corresponds to a roll outer surface of the sheet roll. The first sheet has a first inner surface which corresponds to a roll inner surface of the sheet roll. The second sheet is cut out from a second side of the sheet roll which locates on an opposite side of the first side with respect to a center of a width (W) of the sheet roll. The second sheet has a second outer surface which corresponds to the roll outer surface. The second sheet has a second inner surface which corresponds to the roll inner surface. The first and second sheets are laminated so that the first and second outer surfaces face each other or the first and second inner surfaces face each other.

### BRIEF DESCRIPTION OF THE DRAWINGS

A more complete appreciation of the invention and many of the attendant advantages thereof will become readily apparent with reference to the following detailed description, particularly when considered in conjunction with the accompanying drawings, in which:

FIG. 1 is an explanatory drawing of the section of sheet to be used in the method of manufacturing a laminated sheet according to the embodiment;

FIG. 2 is a view showing division of the section of sheet;

FIG. 3 is an explanatory drawing showing how the sections of sheet are superposed in a first embodiment;

FIG. 4 is a view showing the laminated sheet;

FIG. 5 is a view schematically showing the biaxial rolling that the sheet undergoes in a stage of manufacture;

FIGS. 6(a)-6(b) are views showing the obliquely deformed section of sheet resulting from biaxial rolling and deformation accompanying the recovery of its shape;

FIG. 7 is a schematic view for explaining a reason why twistal deformation is prevented in the laminated sheet manufactured by the manufacturing method according to the present invention;

FIG. 8 is an explanatory drawing showing how the sections of sheet are superposed in a second embodiment;

FIG. 9 is a view showing how the sections of sheet are cut off from the sheet roll (large sheet roll);

FIG. 10 is a view showing warping of the laminated sheet; and

FIG. 11 is a view showing twist of the laminated sheet of FIG. 11.

### DESCRIPTION OF THE PREFERRED EMBODIMENTS

The preferred embodiments will now be described with reference to the accompanying drawings, wherein like reference numerals designate corresponding or identical elements throughout the various drawings.

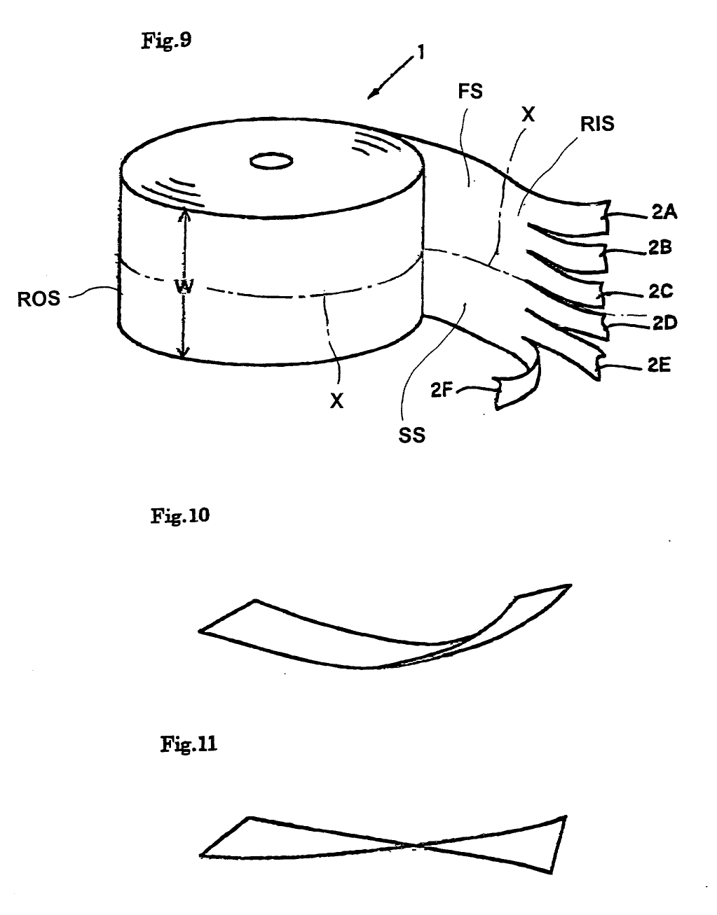

A first embodiment uses either one of the sections of sheet 2A to 2F that are cut off from a sheet roll 1 made of polyester (hereinafter referred to as “large roll”) as shown in FIG. 9 as a starting material (any one of these can be used; in the description below, a section of sheet 2A will be used). Width W of the large roll 1 which is a raw material is set to 1 m here. Moreover, sheet thickness is set to 0.2 mm. Here, it is supposed that one large roll 1 is cut into six equal sections to obtain six sections of sheet 2A to 2F. Therefore, the width of each of the sections of sheet 2A to 2F is approximately 16.7 cm.

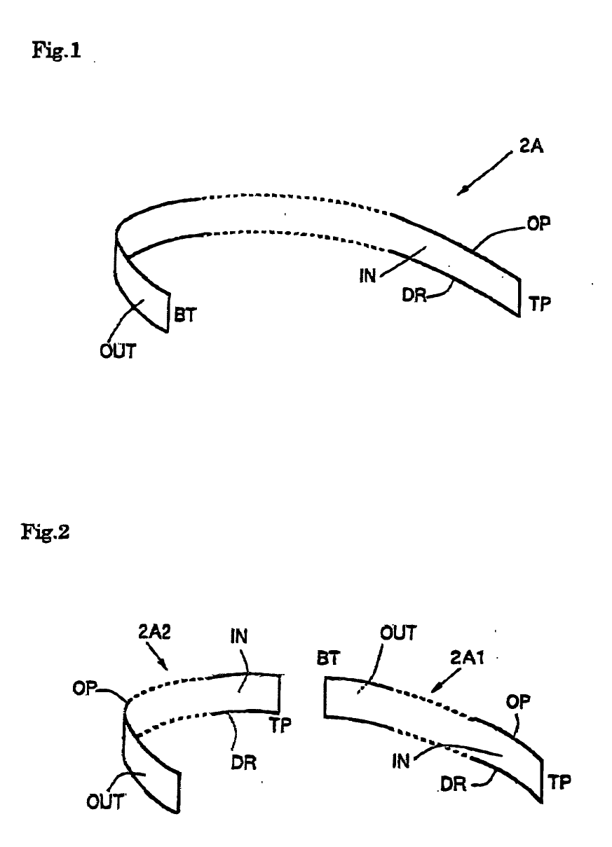

First, the section of sheet 2A will be described referring to FIG. 1 (other sections of sheet 2B to 2F being pretty much the same as the section of sheet 2A). The section of sheet 2A is a long-size sheet, as shown in FIG. 1. About this section of sheet 2A, hereinafter each portion thereof is referred to as follows. First, in the longitudinal direction, one end is referred to as TP, and the other as BT. TP corresponds to a top end (the outermost end) of the large roll 1, while BT corresponds to a rear end (the innermost end) of the large roll 1. Next, in the width direction, one side is referrred to as OP and the other as DR, respectively. OP was also a side in the large roll 1. On the contrary, DR is a portion at which the sheet is cut off from a neighboring section of sheet 2B in the large roll 1. Further, in the thickness direction, one and the other surfaces of the sheet are referred to as IN and as OUT, respectively. IN was an inner surface of the winding in the large roll 1. On the contrary, OUT was an outer surface of the winding in the large roll 1.

Then the section of sheet 2A of FIG. 1 is cut equally in the longitudinal direction to obtain a section of sheet (a first sheet) 2A1 and a section of sheet (a second sheet) 2A2. The first and second sheets (2A1 and 2A2) are cut out from the same side of the roll 1 with respect to a center (X) of the width (W) of the roll 1 (see FIG. 9). Also for the section of sheet 2A1 and a section of sheet 2A2, portion reference symbols TP, BT, OP, DR, IN, and OUT are used just as with the section of sheet 2A.

Further, in addition to the section of sheet 2A1 and the section of sheet 2A2, another sheet is prepared. On this another sheet, a circuit pattern is formed or IC chips are mounted, as needed.

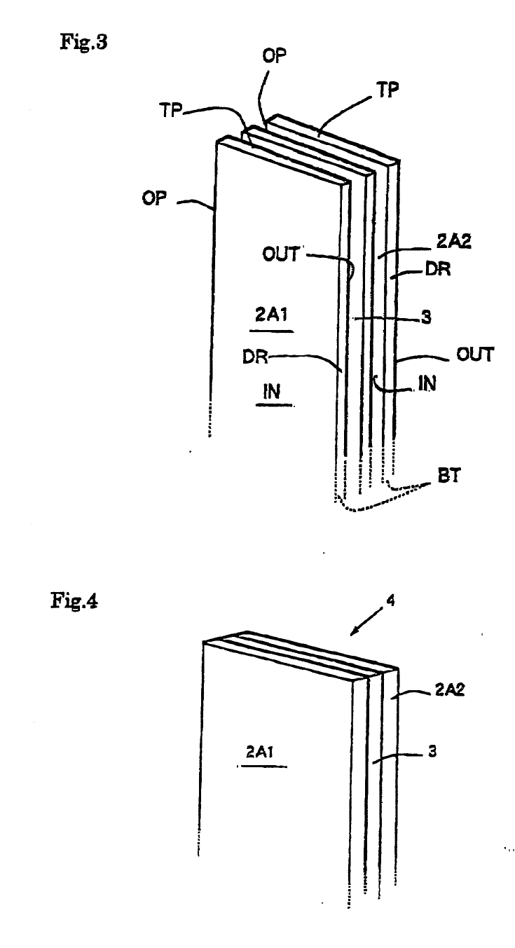

Then, as shown in FIG. 3, the section of sheet 2A1, the section of sheet 2A2, and another sheet 3 are superposed and laminated. A way of superposing the section of sheet 2A1, the section of sheet 2A2, and the another sheet 3 in this process is such that the surface IN of one of the sections of sheet 2A1, 2A2 is made to be opposed to the surface OUT of the other section of sheet, and also TP's of the both sections of sheet 2A1, 2A2 are made to meet each other, so do BT's. Accordingly, OP's, as well as DR's, of the both sections of sheet meet each other, respectively. That is, the width directions of both sections of sheet are mutually parallel. Note that instead of making the TP's as well as BT's of the both sections of sheet meet each other, it may be done that one of the section of sheet 2A1 or the section of sheet 2A2 is rotated by 180 degrees in a plane, and TP and BT of the both sections of sheet may be interchanged. In this case, positions of OP and DR are also interchanged.

Then, when the three sheets are subjected to a heat treatment of about 80° C. with being superposed with each other, the three sheets are laminated together to give a laminated sheet 4 (FIG. 4). This laminated sheet 4 is cut out to a suitable size and is used for applications of a prepaid card, an electronic cash, and the like.

Unlike the conventional laminated sheet, the laminated sheet 4 thus obtained does not develop twist as shown in FIG. 11. This laminated sheet 4 is heated again afterward for coating and the like, but it still does not develop twist. The reason for this is that a way of superposing the sections of sheet 2A1 and 2A2 when being laminated is done in such a way as described above. Hereafter, this way of superposing will be described in detail.

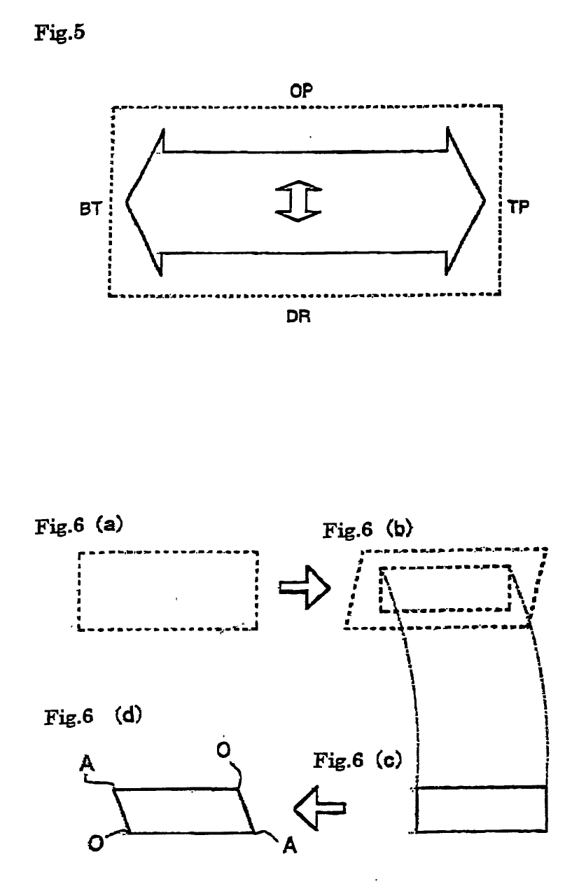

For that purpose, first, characteristics of the large roll 1 will be described. The long-size sheet that was wound up as the large roll 1 is manufactured by biaxially rolling an ingot of a polyester resin. When being manufactured, as shown in FIG. 5, the ingot is flat-rolled with an extremely large ratio of the drafts in a direction TPBT (the longitudinal direction), but the ratio of the drafts in a direction OP-DR (the width direction) is not so large as that in the direction TP-BT. Thus, the ratio of the drafts in the longitudinal direction and in the width direction is very far from 1:1. Moreover, it is thought that the ratio varies according to positions in the width direction of the sheet microscopically. Therefore, it is thought that, in the sheet (especially, portions other than the lateral center), the actual rolling directions are not orthogonal to to each other. Consequently, it is thought that the sheet that was biaxially rolled has undergone oblique deformation (see FIG. 6(a) to FIG. 6(b); note that FIG. 6 is slightly exaggerated for purposes of illustration) in the process of rolling. Then, it is thought that a stress accompanying this oblique deformation remains in the sheet.

Hence, it is thought that when the sheet is heated afterward, the obliquely deformed portion tends to return to its original shape (recover of shape). If such recovery takes place in a single sheet that was not laminated together with other sheets, there appears a deformation (deformation from FIG. 6(c) to FIG. 6(d)) where a rectangular sheet deforms into a parallelogram. However, in the case of the sheets in the laminated sheet, such deformation cannot develop because the sheet is laminated together with other sheets in a form of the plane. Therefore, the section of sheet under consideration deforms in the thickness direction to cause twist as shown in FIG. 11. It is thought that this assumed mechanism results from different tendencies of a portion A where the sides of the parallelogram in FIG. 6(d) make an acute angle and a portion O where the sides thereof make an obtuse angle to either go outward or inward in the thickness direction in the laminated sheet.

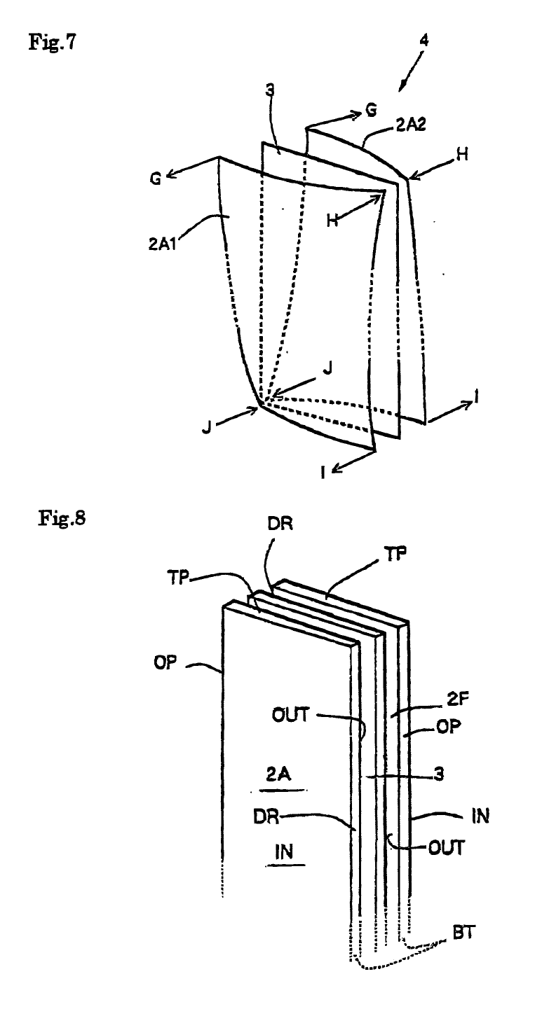

However, in the laminated sheet 4, the sections of sheet 2A1 and 2A2 are superposed as described above. By this arrangement, as shown schematically in FIG. 7, in positions G, I where one of the sections of sheet 2A1 and 2A2 tends to pull the other section of sheet in the thickness direction, the other section of sheet also tends to pull the one section of sheet in the thickness direction (toward an opposite direction). Moreover, in positions H, J where one of the sections of sheet 2A1 and 2A2 tends to push the other section of sheet in the thickness direction, the other section of sheet also tends to push the one section of sheet in the thickness direction (toward an opposite direction). Thus, since deformations of the both sections of sheet offset each other, twist is prevented in the laminated sheet 4 as a whole.

Note that if the both sheets are wrongly superposed, that is, the both sheets 2A1 and 2A2 are laminated, with one of the sections of sheet 2A1 and 2A2 wrong side out, deformations of the laminated sheet in respective positions are doubled, which is contrary to what is intended. If it does so, remarkable twist will develop in the laminated sheet. In the laminated sheet 4 according to this embodiment, such a situation is prevented by superposing and laminating the section of sheet 2A1 and 2A2 as described above.

Incidentally, regarding deformations that may occur in the laminated sheet, besides twist, as described above, there may be also warping as shown in FIG. 10. This warping can be offset through the use of the relation between the sections of sheet 2A1, 2A2 and the another sheet 3. That is, in the way of superposing the sheets in FIG. 3, it is apparent that both of the sections of sheet 2A1 and 2A2 have tendencies of warping toward the same direction regarding warping. Therefore, what is necessary is just to stack the sheet 3 on the sections of sheet 2A1, 2A2 so that the sheet 3 exhibits a tendency of warping reversely to those of the sections of sheet 2A1, 2A2.

A reason why no twist develops in the laminated sheet manufactured by this manufacturing method will be explained as follows. First, a cause of twist which is currently considered to be responsible will be explained. A long-size sheet which is wound up as the sheet roll is usually manufactured by biaxially rolling an ingot made of material such as resin. In the process of rolling, a ratio of the drafts in a longitudinal direction and in the width direction is far from 1:1. Moreover, the ratio is not necessarily uniform in any places of the sheet. Therefore, in the sheet (especially, in portions other than the lateral center), it is thought that the actual rolling directions are not orthogonal to to each other. This means that the process of the biaxial rolling includes deformation that alters a rectangular area in the sheet to an area of an oblique parallelogram (hereinafter referred to as “oblique deformation”). Further, it is thought that a stress accompanying this oblique deformation remains in the sheet of the sheet roll. Because of existence of this stress, when the laminated sheet is heated afterward, the obliquely deformed sheet tends to return to its original shape, which may result in twist of the laminated sheet.

According to the present embodiment, two sections of sheet that were cut off from portions of the sheet roll on the same side with respect to the lateral center thereof are used. These sections of sheet have undergone oblique deformation of the same direction when being biaxially rolled. Therefore, what is necessary is just to laminate these sections of sheet together in such a way that the width directions of the sections of sheet in the sheet roll are made to meet each other (or longitudinal directions of the sections of sheet in the sheet roll are made to meet each other, which achieves the same effect) and that an inner surface of the sheet roll is faced to an outer surface thereof to make the laminated sheet. In the laminated sheet thus manufactured, if the obliquely deformed section of sheet tends to return to its original shape when heated and the like afterward, the following will happen. That is, in a position where one section of sheet tends to pull the other section of sheet outward in the thickness direction, the other section of sheet tends to pull the one section of sheet reversely. Moreover, in a position where one section of sheet tends to push the other section of sheet inward in the thickness direction, the other section of sheet tends to push the one section of sheet reversely. Thus, since deformations of the both sections of sheet are offset, twist is prevented.

In the second embodiment, referring to FIG. 9, for example, a first sheet 2A is cut out from a first side (FS) of the roll 1 and a second sheet 2F is cut out from a second side (SS) of the roll 1 which locates on an opposite side of the first side (FS) with respect to the center (X) of a width (W) of the roll 1. The first sheet 2A has a first outer surface which corresponds to a roll outer surface (ROS) of the roll 1. The first sheet 2A has a first inner surface which corresponds to a roll inner surface (RIS) of the roll 1. The second sheet 2F has a second outer surface which corresponds to the roll outer surface (ROS). The second sheet 2F has a second inner surface which corresponds to the roll inner surface (RIS). In this embodiment, two sections of sheet that were once in symmetrical positions with respect to the center (X) of the width (W) of the large roll 1, selected from among the sections of sheet 2A to 2F that have been cut off therefrom, are used (e.g., 2A and 2F, 2B and 2E, and the like; in the description below, 2A and 2F being used). Moreover, another sheet that is different from these sections of sheet is also used.

Then, as shown in FIG. 8, the section of sheet (a first sheet) 2A, the section of sheet (a second sheet) 2F, and the another sheet 3 are superposed and laminated. A way of superposing the section of sheet 2A and the section of sheet 2F in this process is such that the surfaces OUT of the both sections of sheet are made to be opposed to each other (or the surfaces IN may be made to be opposed to each other) and also TP's as well as BT's of the both sheets are made to meet each other, respectively. Accordingly, the OP and DR of one of the sections of sheet are interchanged, in this order. Incidentally, instead of making TP's as well as BT's meet each other, respectively, it may be done that one of the section of sheet 2A and the section of sheet 2F is rotated by 180 degrees in a plane of superposing and the OP's as well as DR's are made to meet each other, respectively. In this case, the TP and BT of one of the section of sheet meet BT and TP of the other section of sheet, in this order, respectively.

Then, the three sheets are laminated into one integrated body with these sheets superposed, as is the case with the first embodiment. Thereby, the same laminated sheet as is shown in FIG. 4 is obtained. The laminated sheet thus obtained does not develop twist as shown in FIG. 11, just as with the laminated sheet 4 of the first embodiment. The reason is as follows. In the section of sheet 2A and the section of sheet 2F, oblique deformations when being biaxially rolled are made in opposite directions to each other. Therefore, deformations at the time when these deformed sections of sheet return to their original shapes, respectively, are in mutually opposite directions. However, in the way of superposing shown in FIG. 8, the section of sheet 2A and the section of sheet 2F are mutually wrong side out. Because of this superposing, as is the case of FIG. 7, deformations of the both sections of sheet are offset; therefore twist is prevented in the laminated sheet as a whole.

If the sections of sheet are wrongly superposed and laminated while the directions from the front surface to the back surface of the section of sheet 2A and of the section of sheet 2F are made to meet each other, deformation in each position will be doubled. Accordingly, remarkable twist will develop in the laminated sheet. In the laminated sheet according to this embodiment, such a situation is prevented by superposing and laminating the section of sheet 2A and the section of sheet 2F as described above.

Incidentally, in the way of superposing shown in FIG. 8, the section of sheet 2A and the section of sheet 2F have tendencies of warping toward opposite directions, respectively. Therefore, not only twist but also warping are prevented in the laminated sheet as a whole.

However, in order to put this embodiment into practice, it is necessary to use the large roll 1 that has not been sliced after being biaxially rolled. Generally, a mother roll just after the biaxial rolling has a width of 6 m or so, and in many cases the large roll 1 obtained by slicing this mother roll by a width of 1 m is supplied from resin material manufacturers. In the case of such rolls, in order to put this embodiment into practice, it is necessary to use the sections of sheet each of which was taken from the large roll(s) or from a portion of the large roll(s) and both of which were at mutually symmetrical portions of the mother roll of the same distance from the lateral center of the mother roll, respectively.

According to the present embodiment, two sections of sheet which were cut off from portions of the sheet roll on different sides with respect to the lateral center thereof are used. Each of these has undergone oblique deformation in opposite directions when being biaxially rolled. Therefore, what is necessary is just to laminate these sections of sheet together to form the laminated sheet in such a way that the width directions of the sections of sheet in the sheet roll are made to meet each other and that surfaces of the sections of sheet both having the same surface of the sheet roll are made to be opposed to each other, namely, the inner surface to the inner surface or the outer surface to the outer surface. In the laminated sheet thus manufactured, if the obliquely deformed section of sheet tends to return to its original shape (recovery of shape) when heated and the like, the following will happen. That is, in a position where one section of sheet tends to pull the other section of sheet outward in the thickness direction, the other section of sheet also tends to pull the one section of sheet. Moreover, in a position where one section of sheet tends to push the other section of sheet inward in the thickness direction, the other section of sheet also tends to push the one section of sheet. Thus, since deformations of the both sections of sheet are offset, twist is prevented.

In the above described embodiments according to the present invention, it is preferable that the sections of sheet to be laminated together are cut off from one and the same sheet roll so as to ensure that the above-mentioned effect will be certainly obtained. It is further preferable that the sections of sheet to be laminated together are cut off from portions of one and the same sheet roll at positions of the same distance from the lateral center of the sheet roll (in the same position or in symmetrical positions ) and are used. This is because the degree of oblique deformation is considered to be almost uniform if the distance from the lateral center in one and the same sheet roll is equal. Further, in the embodiments according to the present invention, it is preferable that another sheet is sandwiched between the above-mentioned sections of sheet and is laminated together with the sections of sheet. This is done to prevent both twist and warping.

As is evident from the foregoing description, according to the embodiments of the present invention, there can be provided a laminated sheet that is difficult to be twisted even if it is heated afterward when the sheets are laminated together to manufacture the laminated sheet.

As described above in detail, in each of the above-mentioned embodiments, the sections of sheet 2A1 and 2A2 (or 2A and 2F) are superposed and laminated in such a manner that possible deformations at the time when the sections of sheet tend to recover their original shapes are offset, in consideration of the direction of oblique deformation that each section of sheet underwent in the manufacturing process. By virtue of this way of superposing the sections of sheet, there is realized a method of manufacturing a laminated sheet that does not develop twistal deformation even if the laminated sheet is subjected to a heat treatment and the like after lamination.

It should be understood that each embodiment described above is given only by way of example and is not intended to impose any limitations on the present invention. Therefore, it will be understood naturally that various improvements and modifications may be made in the present invention without departing from the spirit and scope thereof. For example, a total number of the sheets that are to be laminated may be more than those of the embodiments.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A method of manufacturing a laminated sheet made from a sheet roll that is formed by biaxially rolling a resin ingot, comprising:
cutting out first and second sheets from a same side of the sheet roll with respect to a center of a width (W) of the sheet roll, the first sheet having an outer surface which corresponds to a roll outer surface of the sheet roll, the second sheet having an inner surface which corresponds to a roll inner surface of the sheet roll; and
laminating the first and second sheets so that the outer surface of the first sheet faces toward the inner surface of the second sheet.

2. A method of manufacturing a laminated sheet according to claim 1, wherein the first and second sheets are cut out from one sheet roll.

3. A method of manufacturing a laminated sheet according to claim 2, wherein the first and second sheets are cut out from the one sheet roll at positions which locate at a same distance from the center of the width (W) of the sheet roll.

4. A method of manufacturing a laminated sheet according to claim 1, further comprising:
sandwiching another sheet between the first and second sheets.

5. A method of manufacturing a laminated sheet made from a sheet roll that is formed by biaxially rolling a resin ingot, comprising:
cutting out a first sheet from a first side of the sheet roll and a second sheet from a second side of the sheet roll which locates on an opposite side of the first side with respect to a center of a width (W) of the sheet roll, the first sheet having a first outer surface which corresponds to a roll outer surface of the sheet roll and having a first inner surface which corresponds to a roll inner surface of the sheet roll, the second sheet having a second outer surface which corresponds to the roll outer surface and having a second inner surface which corresponds to the roll inner surface; and
laminating the first and second sheets so that the first and second outer surfaces face each other or the first and second inner surfaces face each other.

6. A method of manufacturing a laminated sheet according to claim 5, wherein the first and second sheets are cut out from one sheet roll.

7. A method of manufacturing a laminated sheet according to claim 6, wherein the first and second sheets are cut out from the one sheet roll at positions which locate at a same distance from the center of the width (W) of the sheet roll.

8. A method of manufacturing a laminated sheet according to claim 5, further comprising:
sandwiching another sheet between the first and second sheets.

9. A laminated sheet made from a sheet roll that is formed by biaxially rolling a resin ingot, comprising:
a first sheet cut out from one side of the sheet roll with respect to a center of a width (W) of the sheet roll, the first sheet having an outer surface which corresponds to a roll outer surface of the sheet roll; and
a second sheet cut out from the one side of the sheet roll and having an inner surface which corresponds to a roll inner surface of the sheet roll, the first and second sheets being laminated so that the outer surface of the first sheet faces toward the inner surface of the second sheet.

10. A laminated sheet according to claim 9, wherein the first and second sheets are cut out from one sheet roll.

11. A laminated sheet according to claim 10, wherein the first and second sheets are cut out from the one sheet roll at positions which locate at a same distance from the center of the width (W) of the sheet roll.

12. A laminated sheet according to claim 9, further comprising:
another sheet sandwiched between the first and second sheets.

13. A laminated sheet made from a sheet roll that is formed by biaxially rolling a resin ingot, comprising:
a first sheet cut out from a first side of the sheet roll, the first sheet having a first outer surface which corresponds to a roll outer surface of the sheet roll and having a first inner surface which corresponds to a roll inner surface of the sheet roll; and
a second sheet cut out from a second side of the sheet roll which locates on an opposite side of the first side with respect to a center of a width (W) of the sheet roll, the second sheet having a second outer surface which corresponds to the roll outer surface and having a second inner surface which corresponds to the roll inner surface, the first and second sheets being laminated so that the first and second outer surfaces face each other or the first and second inner surfaces face each other.

14. A method of manufacturing a laminated sheet according to claim 13, wherein the first and second sheets are cut out from one sheet roll.

15. A method of manufacturing a laminated sheet according to claim 14, wherein the first and second sheets are cut out from the one sheet roll at positions which locate at a same distance from the center of the width (W) of the sheet roll.

16. A method of manufacturing a laminated sheet according to claim 13, further comprising:
another sheet sanwhiched between the first and second sheets.

17. A method of manufacturing a laminated sheet made from a sheet roll that is formed by biaxially rolling a resin ingot, comprising:
a step for cutting out first and second sheets from a same side of the sheet roll with respect to a center of a width (W) of the sheet roll, the first sheet having an outer surface which corresponds to a roll outer surface of the sheet roll, the second sheet having an inner surface which corresponds to a roll inner surface of the sheet roll; and
a step for laminating the first and second sheets so that the outer surface of the first sheet faces toward the inner surface of the second sheet.

18. A method of manufacturing a laminated sheet made from a sheet roll that is formed by biaxially rolling a resin ingot, comprising:
a step for cutting out a first sheet from a first side of the sheet roll and a second sheet from a second side of the sheet roll which locates on an opposite side of the first side with respect to a center of a width (W) of the sheet roll, the first sheet having a first outer surface which corresponds to a roll outer surface of the sheet roll and having a first inner surface which corresponds to a roll inner surface of the sheet roll, the second sheet having a second outer surface which corresponds to the roll outer surface and having a second inner surface which corresponds to the roll inner surface; and
a step for laminating the first and second sheets so that the first and second outer surfaces face each other or the first and second inner surfaces face each other.
